(19) United States
(12) Patent Application Publication
(10) Pub. No.: US 2010/0256948 A1
(43) Pub. Date: Oct. 7, 2010

(54) Proximity Recording Device and Method

(75) Inventor: David A. Wright, Armidale (AU)

Correspondence Address: FULBRIGHT & JAWORSKI L.L.P., 600 CONGRESS AVE., SUITE 2400, AUSTIN, TX, 78701, US

(73) Assignee: RiForm Pty Ltd., Armidale (AU)

(21) Appl. No.: 12/293,798

(22) PCT Filed: Mar. 20, 2007
(86) PCT No.: PCT/AU07/00338

§ 371 Date: May 21, 2010

(30) Foreign Application Priority Data
Mar. 20, 2006 (AU) 2006901421

(51) Int. Cl. G06F 15/00

(52) U.S. Cl. 702/150; 340/10.1

(57) ABSTRACT

A method is provided of determining a relationship between a first animal and a second animal, which method comprises the steps of: (i) generating a proximity profile comprising information in relation to the frequency and duration of incidences of proximity for a candidate first animal in relation to the one or more candidate second animals; and (ii) analysing the proximity profile to determine whether the interaction between the candidate first animal and any of the candidate second animals is indicative of a relationship between the animals. Also provided is a system for use in such a method.

### FIELD AND BACKGROUND TO THE INVENTION

The present invention relates to methods for determining relationships between animals, such as a genetic relationship, by recording and analysing the frequency and duration of proximity of animals to one another over a period of time.

A significant impediment to genetic improvement of domestic livestock in commercials groups of animals in extensive animal production environments, especially larger farms with in excess of 250 breeding animals, is the cost and impracticality of determining the maternal and genetic relationship between mother and offspring.

In pedigree or stud cattle or sheep operations, the genetic lineage of the offspring is recorded using conventional livestock husbandry practices and methods, i.e. a new born animal is typically identified as belonging to a specific mother either at birth, shortly thereafter or prior to weaning through visual identification.

This is achieved by personnel involved in livestock production completing daily inspections of all newborn animals on a farm and physically determining the identification reference number of each individual offspring and their mother. This may take place by either by visual reading of the number on an ear tag or tattoo of the mother and offspring, or by scanning a barcode or reference number encoded in a microchip using a Radio Frequency Identification Device (RFID). The new reference number for the offspring is then recorded along with the reference number for the mother. This may also include other such information such as date of birth, sex, animal markings etc.

An alternative method used later in life, but prior to weaning, is to separate a group of mothers from their offspring and then return each offspring individually into a holding area containing all the mothers until the mother and offspring are determined visually to have been reunited. This process can be both slow and inaccurate especially if the mother is stressed or if any of the offspring are twins, have self weaned, are sick or have recently been fed, amongst other issues.

However, in most extensive livestock operations, the larger number of breeding animals and the lower level of stocking density, make it impractical to record the genetic identity of offspring in either of these ways, irrespective of cost.

An alternative conventional method of determining an offspring's maternal and paternal relationship is through the use of DNA typing, however this method to-date is cost prohibitive and impractical on a large scale.

Thus, as numbers increase and stocking densities decrease, there is a disproportionate increase in resources required to determine these genetic relationships. Accordingly in most situations throughout the world the recording of the maternal relationship is not undertaken in most larger scale domestic animal breeding programs.

This impediment to genetic improvement (and therefore profitability levels) has long disadvantaged businesses involved in extensive animal production (such as cattle, sheep or goat production) as compared to the businesses involved in intensive animal production (such as pork, poultry and egg production).

This disadvantage in extensive animal production environments is escalated by the long generation interval of cattle, sheep and goats as compared to the short generation interval and rapid generation turnover in intensive animal production industries such as pork and poultry.

Any discussion of the prior art throughout the specification should in no way be considered as an admission that such prior art is widely known or forms part of common general knowledge in the field.

### SUMMARY OF THE INVENTION

The present invention seeks to overcome or ameliorate the impracticalities, impediments, disadvantages and costs of the conventional methods described above by providing a method based on electronic tracking of animals to record and analyse the interactions between animals. For example, in some embodiments the invention has been developed to enable the maternal (and therefore genetic) relationship between a mother and her offspring in live animals to be uniquely identified and recorded. In this context, a significant application of the invention is to facilitate and enhance more rapid genetic improvement in commercial breeding programs in extensive production environments with domestic animals such as cattle, sheep and goats which would otherwise be impractical and cost prohibitive using conventional methods.

This aspect of the present invention is based on the principle that animals who suckle, feed or care for their young, do so with regularity, either every day, or within a minimum period of days. The frequency and duration of proximity of one animal to another animal is designed to match a minimum period when the offspring is feeding or being cared for by a parent. For example in animals who suckle their young, this could include a minimal period or duration when an offspring is feeding from its lactating mother.

In general terms, the proximity between two or more animals, as determined using identifiers such as radio frequency identification devices (RFIDs), is recorded over a period of time and the resulting proximity profile used to establish whether a relationship, such a genetic relationship, a reproductive relationship or a social relationship exists between any of the monitored animals.

The proximity information recorded includes not just simply the number of occasions that particular animals come into proximity, but also the duration of each proximity event. This is necessary since recording only the number of occasions that particular animals come into proximity does not provide sufficient information for a reliable conclusion to be drawn as to whether two given animals are related or are simply in close proximity for durations of time for other reasons.

Accordingly, the present invention provides a method of determining a relationship, such as a social or genetic relationship, between a first animal and a second animal, which method comprises the steps of:

(i) generating a proximity profile comprising information in relation to the frequency and duration of incidences of proximity for a candidate first animal in relation to the one or more candidate second animals; and
(ii) analysing the proximity profile to determine whether the interaction between the candidate first animal and any of the candidate second animals is indicative of a relationship between the animals.

In a related aspect, the present invention provides a method of determining a relationship, such as a social or genetic relationship, between a first animal and a second animal, which method comprises the steps of:

(a) providing one or more candidate first animals with an identifier, such as an electronic identifier;
(b) providing one or more candidate second animals with an identifier, such as an electronic identifier;
(c) generating a proximity profile comprising information in relation to the frequency and duration of incidences of proximity for a candidate first animal in relation to the one or more candidate second animals; and
(d) analysing the proximity profile to determine whether the interaction between the candidate first animal and any of the candidate second animals is indicative of a relationship between the animals.

In one embodiment, the identifiers comprise an RFID device, such as an active or passive RFID device.

In another embodiment, the devices can determine the longitude and latitude, and optionally the altitude, of the identifier's position (e.g. a GPS system).

In a particular embodiment, the incidences of proximity are recorded only when the proximity between an identifier for a first animal and an identifier for a second animal is less than a predetermined distance and the duration of proximity is greater than a predetermined time. In a preferred embodiment, the incidences of proximity are also recorded only when the duration of proximity is less than a predetermined time, in other words the duration of proximity is within a predetermined period of time with either minimum or both minimum and maximum time limits. The advantage of having both minimum and maximum thresholds for duration of proximity events is that it further improves the ability to discriminate true positive data from false positive data.

In one embodiment, the proximity profile for a first animal and a second animal is compared with a table or database of parameters, such as minimum and maximum duration and range thresholds, to determine whether a relationship exists between the first and second animals.

The present invention also provides a system for determining a relationship between a first animal and a second animal, which system comprises:

(i) means for recording the frequency and duration of incidences of proximity between the animals to generate one or more proximity profiles; and
(ii) means for analysing one or more of the proximity profiles to determine whether the interaction between any of the first animals and any of the second animals is indicative of a relationship between the animals.

In a related aspect, the present invention also provides a system for determining a relationship between a first animal and a second animal, which system comprises:

(a) a plurality of identifiers, such as electronic identifiers, for attachment to a plurality of first animals;
(b) a plurality of identifiers such as electronic identifiers, for attachment to a plurality of second animals;
(c) means for recording the frequency and duration of incidences of proximity between the animals to generate one or more proximity profiles, e.g. within specified thresholds or parameters; and
(d) means for analysing one or more of the proximity profiles to determine whether the interaction between any of the first animals and any of the second animals is indicative of a relationship between the animals.

The present invention also provides a system for determining a relationship between a first animal and a second animal, which system comprises:

(i) means for recording the position of the animals at a plurality of time points;
(ii) means for determining the frequency and duration of incidences of proximity between the animals using position data to generate one or more proximity profiles; and
(iii) means for analysing one or more of the proximity profiles to determine whether the interaction between any of the first animals and any of the second animals is indicative of a relationship between the animals.

In a related aspect, the present invention also provides a system for determining a relationship between a first animal and a second animal, which system comprises:

(a) a plurality of identifiers, such as electronic identifiers, for attachment to a plurality of first animals;
(b) a plurality of identifiers, such as electronic identifiers, identifiers for attachment to a plurality of second animals;
(c) means for recording the position of the animals at a plurality of time points;
(d) means for determining the frequency and duration of incidences of proximity between the animals using position data to generate one or more proximity profiles; and
(e) means for analysing one or more of the proximity profiles to determine whether the interaction between any of the first animals and any of the second animals is indicative of a relationship between the animals.

Typically the system of the invention is used in the method of the invention. Accordingly, the present invention also provides the use of the system of the invention for determining a relationship between a first animal and a second animal.

The methods and systems of the invention can also be used in reverse to generate information about the frequency and duration of instances of proximity between animals. This may involve analysing instances of proximity between two animals whose relationship is already known (e.g. having previously been determined by genetic testing). Conversely it may be used to analyse instances of proximity over time for animals whose relationships are not known. The information can be used to generate the thresholds or parameters used to analyse proximity profiles generated subsequently in relation to other animals or groups of animals to determine whether the same relationship exists between two animals whose relationship has not been characterised.

Accordingly, the present invention further provides a method of identifying the proximity thresholds and/or parameters characterising the relationship of interest between a first animal and a second animal, which method comprises the steps of:

(a) providing a first animal with an identifier, such as an electronic identifier;
(b) providing a second animal with an identifier, such as an electronic identifier;
(c) recording instances of proximity between the first and second animal over a predetermined period; and
(d) generating thresholds and/or parameters in relation to the frequency and duration of incidences of proximity between the first animal and the second animal over the predetermined period.

Typically the relationship between the animal is already known. However, in some circumstances, it may also be possible to use the same methodology where the relationship between the two animals has not yet been characterised since the relationship may be readily apparent from the data obtained over a period of time.

The identifiers are such that they are devices that can (i) record and/or transmit proximity and/or location data; or (ii) be interrogated by another device or read remotely. Preferably the identifiers comprise an RFID device, and/or a device that can record and/or transmit the location of the device, such as a GPS device.

### DETAILED DESCRIPTION OF THE INVENTION

Unless defined otherwise, all technical and scientific terms used herein have the same meaning as commonly understood by one of ordinary skill in the art Throughout the description and the claims, the words ‘comprise’, ‘comprising’, and the like are to be construed in an inclusive sense as opposed to an exclusive or exhaustive sense; that is to say, in the sense of “including, but not limited to”.

Throughout this specification, reference to numerical values, unless stated otherwise, is to be taken as meaning “about” that numerical value. The term “about” is used to indicate that a value includes the inherent variation of error for the device and the method being employed to determine the value, or the variation that exists among the study subjects.

The present invention is directed to methods and systems for determining individual animal relationships within groups of animals of the same species, such as social or genetic relationships. The method is used to determine relationships of animals within a group by recording and subsequently analysing the frequency and duration of incidences of proximity between animals, typically by reference to specified thresholds or parameters, as will be discussed in more detail below.

Particular relationships that can be determined using the method of the invention include:
(a) Maternal relationship between mother and offspring
(b) Paternal relationship between father and offspring
(c) Reproductive relationship between an offspring's mother and father
(d) Sibling relationship
(e) Approximate age of progeny based on the likely date of conception and length of gestation for different species and breeds

The methods of the invention can also be used, optionally in combination with other methods and technologies where appropriate, to monitor or determine:
(a) Social contact between animals of the same or different species
(b) Behavioural issues between animals of the same or different species
(c) Reproductive behaviour between animals
(d) Fertility or infertility or fecundity of a father or mother
(e) The timing of mating of animals
(f) The location of all animals for mustering or male animals so they can be withdrawn to control timing of mating
(g) The success of a mother in raising offspring
(h) Parental behaviour
(i) Predatory behaviour between animals
(j) Health, sickness or death of animals
(k) Contact between animals of the same or different species to track disease
(l) Traceability of animals
(m) Monitoring or calculation of methane production for environmental or carbon trading purposes
(n) Animal inventory
(o) The location or theft of animals
(p) Grazing behaviour
(q). Tracking of animals to analyse grazing patterns and utilisation of pasture
(r) Areas where animals can graze or be contained (virtual fences)

The methods may be applied, for example, to determine relationship, such as maternal (and other genetic) relationships in more intensive production environments or in native wildlife populations or to determine social relationships and interaction between live animals in extensive and intensive environments or in native wildlife populations.

The method of the invention may be applied to a range of different animals, including both vertebrates, such as mammals, birds, amphibians, fish and reptiles, and invertebrates, such as insects (e.g. beetles and cockroaches) and crustaceans (e.g. crabs and lobsters). Animals to which the method can be applied may be domesticated (e.g. livestock such as cattle, sheep, goats, horses, camels, pigs, poultry, emus, ostriches, llamas and alpacas). Alternatively, the animals may be wild animals (non-domesticated).

The methods of the invention, especially in relation to determining genetic relationship, can be applied in relation to animals that have offspring only once, every several years, once per year or on more than one occasion during a year.

In a particular embodiment, the animals are those which have regular, daily incidences of parental contact with their offspring following birth or hatching from an egg until weaned, such period being at least a week or a month or several months depending on species or circumstances. This may apply to groups or individual family units.

In one embodiment, the methods of the invention may be used in relation to those animals whose offspring are unable to feed or fend for themselves, and are therefore typically fed or cared for by a parent.

Such animals include those whose offspring suckle from their mothers, typically daily, from the time of birth until weaning. Newly born offspring typically will suckle from their mothers for short durations frequently throughout the day and at night, either at regular or varying intervals. This could be several or more times per day. During these encounters, offspring are in very close proximity with their mothers (i.e. the mouth is attached to the nipple), and it is the duration and frequency of this proximity which forms the basis of identifying a mother/offspring relationship as will be further described below.

In another embodiment, the method may be applied to other animals, including those from the other four classes of vertebrates (birds, reptiles, fish and amphibians) who do not suckle or nurse their offspring but who regularly feed or care for their offspring until they can fend for themselves.

Suckling, nursing or feeding of offspring in the manner described above are hereafter as feeding events.

Typically the frequency of incidences that offspring will be in close proximity with their mother for feeding events will be higher when they are younger but the duration will be shorter. As offspring get older, the frequency of feeding events may reduce, or alternatively build to a peak and then reduce. The duration of each individual feeding event may reduce with time or similarly may increase to a peak before reducing.

Between feeding events, offspring may remain in close proximity with their mothers for extended periods or mothers may move away from their offspring. Extended periods of proximity may include not only feeding events but may include periods of proximity that are not feeding events, here after described as non-feeding events.

Examples of non-feeding events where offspring remain in close proximity with their mother or father include where offspring ride on or are following their mother, are in their mother's pouch, sleeping near their mother or father, being groomed, cared or comforted by their mother or father or simply socialising with either or both parents.

Between feeding events and non-feeding events, offspring may spend time apart from their mother or parents. This may include being with their siblings, with other offspring of different parentage or with mothers or fathers who act as careers or foster parents for offspring in addition to their own whilst an offspring's mother or father are absent for one reason or another. Hereafter feeding events and non-feeding events where offspring are with one or other parent are examples of what are described collectively herein as “relationship events”.

At other times, offspring and parents may spend time on their own. These types of events are described hereafter as non-relationship events.

### Capture and Processing of Proximity Data

Data in relation to the frequency and duration of incidences of proximity events between animals can be subsequently analysed to determine animal relationships. Data in relation to the frequency and duration of incidences of proximity events between two animals is herein termed a proximity profile. A proximity event is where two animals are determined to be within a predetermined minimum distance of one another, which will typically vary between different species. Proximity events may or may not meet the criteria for a relationship event, such as a feed event, which requires further analysis as to the duration of the proximity, typically with reference to parameters such as minimum, and optionally maximum, thresholds.

Data in relation to the frequency and duration of incidences of proximity events between two animals are typically captured directly or derived from raw captured data using one of the following two methods:

Method 1 Logging the positions of individually identified animals at various timepoints and calculating the distances between the animals at those time points.

Method 2 Logging encounters between individually identified animals

An individually identified animal means that the animal has an animal ID number or a RFID device which has been issued to the animal, which allow the animal to be distinguished from other animals. Preferably the animal can be identified uniquely. Individually identified animals will also have an associated record of the animal's details, such as the sex of the animal and optionally an associated record of the year or month or week or date or time or season or other period which can be used to differentiate age or period of birth between animals referred to hereafter as date or period of birth (referred to herein as associated data). These data may be stored in a database separately located from each animal, or stored on an animal identifier, such as an RFID device along with a unique animal ID.

When processing information about animals from many different groups of animals, other additional information may be required such as ownership identification; and/or group identification to which animals belong.

In broad terms, method 1 derives proximity data by firstly capturing or determining the position of individually identified animals, either continuously or at predetermined intervals, such as at least every second or 10 seconds or at least every minute. The position can be provided in absolute terms (e.g. geographical longitude and latitude coordinates) or relative to a fixed point (e.g. xy coordinates or distance and angle). Position information will have an associated timestamp so that duration of proximity can also be determined. The time stamped position data for each individually identified animal can then be used to calculate the distance between any two animals at a given time.

These data are then further processed to determine whether any two particular animals are within minimum specified distances at particular time points. Such instances are recorded as proximity events. These proximity events are then further processed to establish the duration of the proximity. Typically this can be performed by simply grouping together sequential proximity events (i.e. where the animals are within the minimum specified distance at each time point) to form a proximity event set and then determining the duration of proximity by calculating the interval between the first proximity event in the set and the last proximity event in the set. The result is a time stamped record of the duration of proximity between the two animals (“a proximity record”). These time stamped records collectively form a proximity profile between the two animals.

In broad terms, method 2 derives proximity data by capturing directly proximity events between two animals. In this case, whenever two animals come within range (i.e. within a minimum predetermined distance, typically as determined by the radio range of RFID devices attached to the animals), a timestamp is recorded and when the two animals move out of range, the total duration of proximity is also recorded resulting in a time stamped record of the duration of proximity between the two animals. Again, these time stamped records (proximity records) collectively form a proximity profile between the two animals.

The proximity profile obtained by either method 1 or method 2 or by any other suitable method is then analysed as described in detail below, typically in combination with animal specific data such as the age and sex of the animals to determine whether a particular relationship exists between the animals.

The minimum period over which proximity data will need to be recorded will vary from species to species depending on the number of occasions per day that the two animals come into proximity consistent with the desired relationship. For example, when the method is used to determined a mother/offspring relationship based on feeding events, some species exhibit a large number of feeding events per day (e.g. sheep) and it will often be possible to obtain sufficient information in less than 24 hours to enable a reliable match. However other species exhibit only a few feeding events per day, such as only one or two, and in that case it will often be necessary to record and analyse proximity data for more than one day, such as two or more days, or at least a week. Some species, such as birds, may only feed their offspring once every several days and therefore it may be necessary to obtain proximity data over a period of weeks rather than days.

For example a particular species of bird which, for the purpose of illustration is called a “Far-Far” bird, may fly far, far away for a period of up to 5 days. The bird must return and feed its young within 5 days or its offspring will die. The bird may return within 5 days and feed its offspring for a few minutes and then depart again in search of food. Over a period of weeks, the specified thresholds or parameters of frequency and duration of proximity when compared to the actual pattern of the bird feeding its offspring will enable the relationship between parents and offspring to be determined. The Far-Far bird may nest within 30 centimetres of a another nest. The unique patterns of frequency and duration of proximity of Far-Far birds from each nest are used to discard false positive encounters between incidences of parents with offspring in nests that are not their own.

Accordingly, in one embodiment, proximity data are recorded or otherwise derived for at least two or more consecutive days, e.g. for two to five days or at least a week. In another embodiment, proximity data are recorded or otherwise derived for at least two or more weeks.

In some embodiments it may only be necessary to record proximity data during daytime whereas in other embodiments it may only be necessary to record proximity data during night time, depending on the type of relationship being determined.

### Mounting Events

In addition, devices used to record proximity events with males (or fathers) may also incorporate a capability of collecting records of the male mounting a female and may also record the direction or heading faced by the father and mother described as “Mounting Events”. Alternatively records of Mounting Events may be recorded in a separate device that also records the time of the Mounting Events.

Mounting Events as recorded in male animals that are determined to be in close proximity to a mother, can be used to determine the timing of a reproductive event between a mother and father. A Mounting Event is recorded when the angle of an animal relative to the ground changes or reaches a minimum angle when a father mounts a female during a period of oestrus.

The combined proximity profile and record of Mounting Events can then be analysed to determine the conception date and therefore the age of any Offspring. This information may also be able to be used to determine the possible father of any offspring.

In another embodiment, these data may be used to determine the fertility or infertility or fecundity of fathers or mothers. For example where multiple potential fathers may available to join with a mother, a dominant male may be responsible for the majority of mounting events but as a consequence of his infertility may result in many mothers not conceiving during a given oestrus cycle or over several oestrus cycles. Conversely only a portion of mothers may conceive to such a father. Alternatively a mother may be served but she herself does not conceive. Accordingly the method can be used to identify mothers who are infertile or have low levels of fertility or fecundity.

### Analysis of Proximity Profiles

Proximity profiles may be analysed manually or using a computer-implemented algorithm. The process of analysis generally involves comparing the frequency and duration of proximity against parameters (including parameters such as minimum, and optionally maximum, thresholds for duration of proximity) which are characteristic of a particular type of relationship between two animals of a given species (and where applicable lower taxonomic classifications such as breeds, varieties, subspecies, races etc.). The parameters can be adjusted not only for different species but also for other biological factors such as age, health, number of offspring, number of teats, group size, as well as environmental factors such as geographical location, vegetation (e.g. forest, open ground), terrain, pasture and nutrition, distance to water, climate, season, mating season, weather conditions, and presence of predators.

Two possible approaches to analysing a proximity profile are (i) counting the frequency of incidences of proximity of predetermined or specified duration; and (ii) counting total duration of proximity by summing the duration of all recorded proximity events. The first, and preferred, approach uses a specified duration threshold or parameter to validate each proximity record. A validated proximity record is a proximity record which meets the specified duration parameter and is herein termed “a relationship event”. The other parameter is the frequency of validated proximity records (relationship events—i.e. frequency of proximity records of specified duration).

“Specified duration” (also termed “predetermined duration”) is a parameter or parameters which include at least a minimum duration value and optionally a maximum duration value (such that the two values combined provide a range of valid durations). Whilst a maximum duration parameter is not always be required, we have observed in some cases that animals under some conditions may huddle together in close proximity for extended periods of time (e.g. in the shade during the heat of the day). The use of a maximum duration parameter assists in eliminating such interactions from the validated data set and reducing or avoiding false positives.

Similarly, frequency of events may also be specified as a range, having a minimum and maximum value, which may be characterised in terms of a minimum and maximum value per day or any other appropriate time period.

Irrespective of the technologies employed to measure the frequency and duration of intervals of proximity, the resulting proximity profile is subsequently analysed against a set of parameters (such as duration thresholds) which are characteristic of a desired relationship, at least to the extent that they serve to exclude false positives. As mentioned above, the analysis is conveniently conducted by means of a computer implemented algorithm.

The algorithm can be calibrated for different parameters and criteria to allow for a range of factors between species to analyse proximity profiles to determine relationships between animals. In many cases, parameters can be derived from a range of studies have previously been conducted into the nature of relationships between various animals.

Determination of parent/offspring and offspring/offspring relationships, for example is based on the fact that offspring will be in close daily proximity with their mother or father or other offspring regularly for feeding events, whether they are suckled or fed until weaned. A number of studies have analysed this relationship in different species. For example, Ewbank, 1967, Animal Behaviour 15: 251-258 and Ewbank, 1963, Animal Behaviour 12: 34-37 provide the data set out in the table below in relation to suckling duration and frequency for lambs.

The data provided by Ewbank can be used to generate, for example, parameters which specify for lambs that are less than 5 weeks old, a minimum frequency of at least 8 events per day of minimum duration 10 seconds and optionally a maximum duration of 50 seconds.

Lambs - Mean Duration of Individual Suckling Periods/12 Hours

| | |
|---|---|
| Approximate | |
| Age of Lambs | Average Suckling Duration (Seconds) |

| (Weeks) | Single Lambs (12) | Twin Lambs (14) |
|---|---|---|
| 1 | 41 | 42 |
| 2 | 33 | 31 |
| 3 | 20 | 19 |
| 4 | 15 | 17 |
| 5 | 13 | 15 |
| 6 | 13 | 13 |
| 7 | 14 | 14 |
| 8 | 14 | 13 |

Lambs - Mean Frequency of Suckling Rate/12 Hours¹

| | |
|---|---|
| Approximate | |
| Age of Lambs | Average Suckling Rate per Day |

| (Weeks) | Single Lambs (12) | Twin Lambs (14) |
|---|---|---|
| 1 | 15 | 23 |
| 2 | 12 | 17 |
| 3 | 11 | 13 |
| 4 | 10 | 9 |
| 5 | 10 | 9 |
| 6 | 9 | 9 |
| 7 | 8 | 8 |
| 8 | 7 | 5 |

¹Rounded to the nearest zero

Other studies show that calves suckle about 4 or 5 times a day for about 6 to 12 minutes. The minimum duration could therefore be set as 5 minutes with a minimum frequency of 3 events per day. An optional maximum duration of 15 or 20 minutes could also be specified.

Other data for suckling of Charolais cross calves show a duration range of from 6.9 to 10.7 minutes with an average of 5.5 occurrences per day (Somerville S. H., Lowman B. G., 1979, Applied Animal Ethology, 6: 369-373). Data for Zebu calves show an average duration of 9.2 minutes (total duration 64 minutes) with an average daily frequency of 6.7 (Hutchison H G, Woof R M, Mabon R M, 1962, J. Agric. Sci. Cambridge 59: 301-315).

Other studies show that each different species has different frequencies and duration of nursing and suckling periods. For example European bison calves feed for about from 5.5 to 7 minutes at an average frequency of about 12 times per day (Daleszcyk K., 2004, Acta Theriologica 49 (4): 555-566). Dolphin calves feed about 4 times per hour for several seconds, decreasing with age. Rabbits, by contrast, typically feed only once a day, for a few minutes.

Calibration to derive parameters relevant to particular conditions or situations may be necessary to account for differences in frequency and duration of incidences of proximity for relationship events that exist between species and to adjust for factors which will result in, variations in daily frequency and duration of incidences of proximity (as described above). For example, the frequency and duration of intervals of proximity for feeding events tend to vary according to two main factors, namely (i) species or breed, and (ii) age of offspring. However, feast or famine for example may substantially change the normal pattern of frequency and duration for a given species, breed or age of offspring which will impact on the calibration required.

In addition, factors such as geographic location, prevailing weather conditions and other circumstance may result in variations to normal frequency and duration of incidences of proximity of suckling, feeding or care events. For example unrelated animals may have been in close proximity for extended periods of duration during the day or as measured over a period of time while resting, ruminating or sleeping. Under these conditions, parameters may need to be adjusted to filter out false positive data generated during an extended period of duration of proximity e.g. when animals seek shelter under the shade of a tree for several hours during the heat of a day. Other examples include while foraging or feeding from a trough, while drinking from a trough, stream, while huddled close together for several hours or more during periods of extreme cold or for other reasons.

Some species and breeds will forage or socialise close to each other in groups, individuals and other groups may be spread out over a wide area at different times of the day. The size of the paddock or enclosure, the amount of shelter, available forage or food, predators etc. will all have an influence on variation in normal proximity profiles.

Breed differences may also account for variations in normal proximity profiles when animals experience different climatic or seasonal conditions. For example Bos taurus breeds of cattle are more sensitive to heat but better adapted to cold climatic conditions than Bos indicus I Sanga breeds of cattle. During a hot day, Bos taurus breeds of cattle will stand or lie beneath the shade of a tree in close proximity with each other for several hours at a time. During this time, offspring may suckle from their mother. However in these circumstances, offspring typically will also suckle during the cool of the morning or evening when they are not closely grouped under the shade of a tree. In this instance the incidences of proximity where the duration exceeds the upper threshold for normal suckling events must be discarded from the analysis, irrespective of whether offspring suckled from their mother during this time. Similarly, when animals are grouped together for other reasons, such as described above, these data also need to be discarded. These factors may result in an increase in the period of days or time required during which an analysis of frequency and specified duration of proximity must be undertaken. Likewise, the maximum threshold for daily frequency may also need to be reduced.

Differences between species and breeds may also account for behavioural variations in proximity between parents and offspring when foraging or hunting or as they move from foraging areas, or hunting grounds, to water points. Depending on the species and age of the offspring, and the size of the enclosure or paddock in which animals may be located, parents which feed or suckle their offspring (i.e. cattle or sheep) may leave their offspring while walking large distances to water in the cooler parts of the day, typically in the evening. This is especially the case when offspring are younger. During these occasions, parents and offspring will obviously be outside a minimum proximity range during which proximity events can be recorded whilst located at water points. In smaller enclosures or paddocks or when older, offspring may walk to watering points with their parents. However it is well known that dominant animals will drink from a water point before less dominant animals until their thirst is quenched. This is especially the case where water points are troughs. In hot conditions, the more dominant animals will drink closer to the water inlet in a trough where the water is fresh and cool. Less dominant animals will drink further away from the inlet or will wait until space at the trough is available. In these circumstances offspring will also wait until parents have quenched their thirst. The size, shape and access to a water trough will also have an influence on behaviour of dominant or less dominant parents and offspring. Proximity events recorded during these occasions need to be filtered from records of Feed Care Events and discarded as non validated data. In some enclosures or paddocks which have troughs or permanent water points, there may be many natural water points which will fill and empty during periods of wet or dry seasonal conditions. For these reasons it is necessary to determine proximity of animals to each other rather than proximity of a parent and offspring to a fixed point.

Another factor which may otherwise result in a false positive relationship match without having analysed proximity data in accordance with specified thresholds or parameters for frequency and duration of proximity exists when offspring rob or steal food from another parent. In cattle for example this is termed “cross suckling”. Incidences of cross suckling may occur with single calves but is often observed more frequently in the case of twin calves. Whilst twins regularly suckle their own mother they may be opportunist and also suckle from another mother. However it is well known from the literature that the frequency and duration of cross suckling will usually be less than the normal thresholds. Accordingly in order that false positive information which arises from cross suckling is discarded, suitable minimum and maximum thresholds should be specified.

The required parameters can also be derived by studying known relationships between identified animals. Such parameters can be derived by visual observation and/or by capturing data using the systems described herein.

In one embodiment, the minimum duration for a proximity record to be classed as a relationship event is at least 10 seconds, such as least 20 or 30 seconds.

In some embodiments, where data are recorded over two or more days, the analysis of the data may take into account that many relationship events would be expected to occur on a number of consecutive days. For example, offspring who rely on their parents for food (either by suckling or food) or care will for many species do so each day. The table or database of parameters may therefore also include a minimum consecutive days parameter. Data are recorded over a number of consecutive days. If initial analysis of the data for two animals of interest shows that there is not at least one proximity event, or validated proximity event, each day for the minimum number of consecutive days specified by the consecutive days parameter then a negative result is generated without the need for more detailed analysis. This approach can be used to assist in eliminating or reducing false positives for relationship events that would be expected to occur either daily or on at least a specified minimum number of consecutive days.

By way of example, a table or database of parameters for a species such as rabbits whose offspring feed once per day for about 2 minutes per day could be as follows:

| Species_ID | rabbit |
|---|---|
| Males_can_feed_or_care | Y |
| Offsping_minimum_age_days | 1 |
| Offspring_maximum_age_days | 10 |
| Minimum_daily_feed_care_frequency | 1 |
| Maximum_daily_feed_care_frequency | 1 |
| Minimum_feed_care_duration | 1 minute |
| Maximum_feed_care_duration | 3 minutes |
| Minimum_range | 30 cm |
| Minimum_consecutive_days | 3 |

For another species such as sheep where offspring feed more frequently but for less time:

| Species_ID | sheep |
|---|---|
| Males_can_feed_or_care | N |
| Minimum_daily_feed_care_frequency | 10 |
| Offsping_minimum_age_days | 1 |
| Offspring_maximum_age_days | 7 |
| Maxiumum_daily_feed_care_frequency | 25 |
| Minimum_feed_care_duration | 20 seconds |
| Maximum_feed_care_duration | 50 seconds |
| Minimum_range | 100 cm |
| Minimum_consecutive_days | 1 |

A different table or database of parameters may be used at different ages as feeding patterns change, or a combined table or database which covers the full range of ages. E.g. for the sheep example in week 8:

| Species_ID | sheep |
|---|---|
| Males_can_feed_or_care | N |
| Minimum_daily_feed_care_frequency | 3 |
| Offsping_minimum_age_days | 49 |
| Offspring_maximum_age_days | 56 |
| Maximum_daily_feed_care_frequency | 10 |
| Minimum_feed_care_duration | 10 seconds |
| Maximum_feed_care_duration | 30 seconds |
| Minimum_range | 100 cm |
| Minimum_consecutive_days | 3 |

Where sheep for example are monitored from week 1 to week 8 the table or database of parameters may cover the full range of thresholds or parameters for all ages. E.g. for example:

| Species_ID | sheep |
|---|---|
| Males_can_feed_or_care | N |
| Minimum_daily_feed_care_frequency | 3 |
| Offsping_minimum_age_days | 1 |
| Offspring_maximum_age_days | 56 |
| Maxiumum_daily_feed_care_frequency | 25 |
| Minimum_feed_care_duration | 10 seconds |
| Maximum_feed_care_duration | 50 seconds |
| Minimum_range | 100 cm |
| Minimum_consecutive_days | 3 |

### Processing Algorithm

The processing software algorithm may be capable of analysing proximity data to determine only one type of relationship or it may be designed to determine a plurality of relationships e.g. using different modules. Essentially proximity records are analysed and validated against a table or database of thresholds/parameters recorded in a reference database for a particular relationship for a particular species (optionally with other factors, such as the biological and environmental factors described above, taken into account). A number of different types of relationship determinations are described in more detail below, by way of example.

### I. Mother (or Father)-Offspring Determination in Feed-Care Scenario.

### II. Sibling Determination in Feed-Care Scenario.

### III. Conception Determination.

### IV. Father-Offspring Determination and Offspring Age in Conception Scenario.

A table or database of parameters may be provided which contains information, such as parameters/thresholds for frequency and duration about each species or subspecies. For each species or subspecies the database may comprise a plurality of subtables reflecting variations in duration and frequency parameters under different biological or environmental conditions. At the start of processing for each module, the table or database of parameters is read and relevant information for that module is extracted. This information is termed “species master data” because it is non-changing during the processing cycle and also, it is not subject to interpretation. In the description of each of the five modules a description is given of the master data to be included in the processing for that module.

There are a few pieces of master data, which are further described now to obviate the need to repeat these detailed description in the module descriptions below.

| | | |
|---|---|---|
| MinDailyFeedCareEvents | Integer | Number/day |
| MaxDailyFeedCareEvents | Integer | Number/day |
| MinFeedCareDuration | Integer | Seconds duration |
| MaxFeedCareDuration | Integer | Seconds duration |
| MinRange | Integer | Centimetres |
| MinDataDays | Integer | Days |
| MinOffspringAgeDays | Integer | Days |
| MaxOffspringAgeDays | Integer | Days |
| Gestation | Integer | Days |
| MinOestrusCycleDuration | Integer | Days |
| MaxOestrusCyleDuration | Integer | Days |

Minimum and Maximum Daily Feed-Care Events thresholds exists for species which have either a mother or father involved in daily feeding or caring for their young. So if the expected range of Feed-Care Events, for the group in question, for the offspring generation in question, is for example between 5 and 10, as in between 5 and 10 feeding events per day, then these would be the values to which we would set these variables.

Minimum and Maximum Feed Care Duration thresholds again exists for those situations in which there are daily feed or care events (if so then the expected minimum and maximum duration thresholds for such an event are stored here—for example between 3 and 10 minutes duration).

Minimum Range. For a number of processing modules, part of the decision making is determined by the physical proximity of the animals. So with this variable a minimum required range can be set which is used to determine that the animals are close enough together to allow consideration that a particular behaviour might be occurring, such as mating or parent assisted feeding.

Minimum Data Days. To obtain desired accuracy, we specify a minimum number range of days over which data need to be collected (one or more). This value goes in this variable.

Minimum and Maximum Offspring Age Days These thresholds are description information contained in the master data to differentiate between different ages of offspring that information about proximity data may be collected for as described in Minimum and Maximum Daily Feed Care Events and Minimum and Maximum Feed Care Duration.

Proximity Time Threshold. This parameter is used to specify the minimum time interval between which two pieces of time stamped data are determined to be within the same data set. For example, if this parameter is set to 5 seconds, any two pieces of data within 5 seconds of each other are considered to be part of the same event data set (proximity record), like a mating event, or a feeding event. Re-stated this parameter could also be viewed as the maximum allowed “gap” in the data which still allows two pieces of data to be included in the same event data set.

Gestation This parameter records the average duration of gestation from conception to birth in days for a given species or breed.

Minimum and Maximum Oestrus Cycle Duration These thresholds provide the expected range which may be expected for oestrus cycles for different species and breeds.

### Functional Case #1—Mother-Offspring Determination in Feed-Care Scenario

### 1. Input File: Master Data.

Proximity Time Threshold
MinDailyFeedCareEvents
MaxDailyFeedCareEvents
MinFeedCareDuration
MinRange
MinDataDays

### 2. Input File: Group Identifying Data

RFID The animal's RFID or other electronic ID number
Mother/Offspring Whether the animal in question is a potential mother or a potential offspring. Can also be determined from age data.

### 3. Input File: Location Data

RFID The animal's RFID or other electronic ID number
Date Time Stamp The date/time of the event, formats vary by device, but typically includes Month, Day, Year, Hours, Minutes, Seconds, Sub-Second
Latitude
Longitude
Altitude.

### 4. Output/Input File: Proximity Events Data

Offspring RFID
Mother RFID
Date Time Stamp
Distance The distance between the indicated offspring and the indicated mother at the indicated time

### 5. Output/Input File: Proximity Event Sets

Offspring RFID
Mother RFID
Date
Proximity Event Set Count The count of Proximity Event Sets (proximity records), on the indicated date.

### 6. Output File: Match File

Offspring RFID
Mother RFID

### 7. Processing:

Read Master Data and perform set up steps.

Read Group Data sort in memory by RFID.

If input data is GPS data, then Read Location Data and sort in memory by RFID.

Initialise the intermediate file.

If input data is RFID data then populate the intermediate file directly from the RFID Input Data. The offspring RFID and mother RFID are copied directly from the RFID raw data, as well as the date/time stamp. The distance is read in as a device parameter.

Otherwise, if GPS data, then process the location file and generate the intermediate file internally. The primary two steps in this processing are:

(a) Ensure, for a given mother/offspring combination, that a given row is within the Proximity Time Threshold of at least one other (different) row.

(b) Calculate (GPS data only) the distance between the offspring and the mother using the Euclidean 3-space distance metric. Then test to ensure that this distance is less that the Minimum Distance value contained within the Master Data.

After the intermediate file is built, then sort the intermediate file by RFID and timestamp. Then reprocess the intermediate file. If there is more then one occurrence of a proximity event (a row in the intermediate file) within the duration of MinFeedCareTime and MaxFeedCareTime, then create/update a row in the Proximity Event Set output file.

After the Proximity Event Set output file is built, reprocess comparing the number of proximity event sets for a given day, for a given mother/offspring combination, to the MinimumDailyFeedCareEvents and MaximumDailyFeedCareEvents Master Data.

Also compare the numbers of consecutive days of data collected is within the MinDataDays Master Data. If the number of days of collected data is less than the Master Data requirement, then print a message to that effect and cease processing.

Otherwise, if the number of Proximity Event Sets for a given day, for a given mother/offspring combination is within the MinimumDailyFeedCareEvents and MaximumDailyFeedCareEvents parameter, for each day in the data set, then record that mother/offspring combination as a match and write an output row into the Match File.

Perform Wrap Up processing and close all files.

This module, with appropriate changes to the data types, can also be used for determining father/offspring relationships in species in which fathers engage in some type of regular/daily feed/care event with their offspring, such as happens in some species of animals.

### Functional Case #2—Sibling Determination in Feed-Care Scenario

The sibling determination module, requires the existence of one or more match files outputted from the mother/offspring module.

Process the match file. For each mother/offspring matched combination which share the same mother and but different offspring, write a row into the Sibling Match File structured as follows:

### Output File: Sibling Match File

### Offspring_{—}1 RFID

Offspring_{—}2 RFID (etc)

### Mother_RFID

### Functional Case #3—Conception Determination

For species which are capable of generating “Mounting Event” data, this module which produce a output file containing potential conception events.

### 1. Input File: Master Data.

### Proximity Time Threshold

### Mounting Event Time Threshold

### MinRange

### 2. Input File: Group Identifying Data

RFID The animal's RFID or other electronic ID information
Mother/Father Whether the animal in question is a potential other or a potential father.

### 3. Input File: Location Data

RFID The animal's RFID or other electronic ID number
Date Time Stamp The date/time of the event, formats vary by device, but typically includes Month, Day, Year, Hours, Minutes, Seconds, Sub-Second
Latitude
Longitude
Altitude.

### 4. Mounting Event Data

Father RFID The RFID or other electronic identification for the father.
DateTime The date and time of the “Mounting Event”

### 5. Output File: Conception File

### Father RFID

### Mother RFID

DateTime Of the Mounting Event generating this match

### Gestation

### MinOestrusCycleDuration

### MaxOestrusCycleDuration

### 6. Processing

Read in the Oestrus thresholds and gestation data from the Master Data

Read in the location file.

Read in the Mounting Event file.

Compare the Mounting Event File data to the Location File data, matching on Father RFID. If a Father ID is within Proximity Time Threshold of a Mother RFID and the locations are with Minimum Range and a Mounting Event Occurred within the Mounting Event Time Threshold then write record this as a conception record. Once all conception records have been generated, analyse the dates of conception records in accordance with oestrus cycle thresholds from the specie Master Data and discard Mounting Events for oestrus cycles prior to the final oestrus cycle as recorded by the last Mounting Events. Calculate an estimated conception date based on an average of the conception date from the remaining records of Mounting Events of the final oestrus cycle. Add the gestation period to the estimated conception date to determine an estimated birth date. Output the estimated conception date and estimated birth date.

### Functional Case #4—Sire and Offspring Age Determination

The Sire Determination and Offspring Age module requires input from the Mother/Offspring Determination in Feed-Care Scenario module, as well as the Conception determination Module.

Collect one or more Match Data sets from prior mother/offspring matching.

Collect one or more Conception File Match data sets from prior father/mother matching.

Read in both groups of data sets.

Match the mothers in the mother/offspring data sets to the mothers in the father/mother data sets.

Select those offspring whose mothers mated with the matched fathers.

If a mother matches with the same father twice, reject all but the most recent matching combination.

Write out an output file as follows:

### Output File: Sire and Offspring Age Determination (csv Format)

### Father RFID

### Mother RFID

### Offspring RFID

### Estimated Conception Date Time

### Estimated Birth Date Time

### Systems and Methods for Collecting Data

Proximity events between animals can be recorded or logged using any suitable technology or combinations of technologies. Each animal is fitted with what is termed an identifier which forms the basis for the capture of location and/or proximity data. An identifier is a device or label that allows location and/or proximity data to be recorded without the animal needing to be observed by a human operator. Accordingly, where data are captured in relation to each animal's location, the identifier needs to be capable of either (i) determining and recording or transmitting its position or (ii) being interrogated by remote, means e.g. by an RF signal such as radio or radar to determine its position. Where proximity data are captured directly, the identifiers for at least one class of animals (e.g. parent animals) need to be capable of interrogating the identifiers on other animals to determine whether the animals are in proximity (e.g. active RFIDs on parent animals which interrogate passive RFIDs on offspring animals or vice versa or both). Identifiers may use various different communications protocols or mediums such as radio frequencies (HF, VHF, UHF, FM or other frequencies), Bluetooth, infrared, passive or active RFID technology, ultrasonic frequencies, acoustic technology, and other common wireless communication methods and protocols. Examples of technologies which can be used are described below.

The data may be recorded or logged in many different formats providing the data required to analyse relationship can be converted or derived from the recorded/logged information. Data may be recorded continuously, at specified intervals (e.g. every second, every 10 seconds, or every minute) or only during periods of proximity.

The data to be recorded is typically one of two core types: (i) a record of position or coordinates of individual animals as they move about; or (ii) a log of incidences of proximity in such a format that the duration of proximity is either recorded directly, counted or can be derived e.g. from time stamped incidences of proximity recorded at periodic intervals.

Data records of location and/or proximity are monitored, collected, recorded or communicated from individually identified animals. Other related information (associated data) which is required to determine the relationship between animals from proximity events (such as the sex, period or date of birth etc. of each uniquely identified animal) may be collected at different times during an animal's life and stored in a separate database or databases.

The systems for analysing the captured data are termed herein proximity analysis systems. The overall system which combines identifiers/proximity devices and the systems for analysing the captured data (the proximity analysis systems) is hereafter described as the proximity recording and analysis system.

An identifier is typically a device or label/tag which enables an animal to be identified by scanning the device or label tag or by reading a signal emitted by the identifier. Identifiers therefore include devices such as RFIDs. Identifiers can be either passive or active. Animals can be fitted with either a passive identifier or an active identifier or both.

Passive RFID identifiers may include a passive machine readable electronic RFID chip. Alternatively a passive RFID identifier could include an identification code printed with conductive ink that can be read by a remotely located electronic scanning system. Such a system could also be used to triangulate the position of individual animals and generate proximity data about proximity events between animals.

Animals may further comprise a reader for reading other identifiers when those other identifiers are within a predetermined distance or range. The reader generates a read signal to which other identifiers are responsive. Other identifiers in range receive the read signal and broadcast their own ID signal back to the reader, which receives the ID signal and logs the data. Such readers may optionally include a processor and data storage for storing logged position or proximity data and/or a transmitter to relay logged data to a remote terminal or station. The reader may be separate to, or integrated with, the identifier.

Alternatively, animals may be fitted with means for determining the location of the identifier, either in absolute terms (e.g. a GPS device), or relative to a fixed point or points, i.e. a locating device. Such locating devices will therefore typically comprise a receiver and optionally a transmitter. The devices may optionally include a processor and data storage for storing logged position or proximity data and/or a transmitter to relay logged data to a remote terminal or station. The locating device may be separate to, or integrated with, the identifier.

Identifiers or associated readers/locating devices may also collect, log, store and communicate proximity and/or position data.

Identifiers can be physically located either inside each animal or attached to it, for example attached to a neck collar (e.g. in a waterproof and toughened capsule) on the animal, in a tag attached to the animal's ear, in a bolus contained in the animal's stomach; implanted by way of subcutaneous injection e.g. in the scutiform cartilage at the base of the ear, under the dewclaw of one of the legs, or into a bone of the animal; or positioned at some other locality on or in the animal's body.

By way of example, following birth and prior to weaning, most likely during a livestock production event known as marking (or branding), a microchip Radio Frequency Identification Device encoded with its own unique number is attached to the offspring. This device may be attached to the offspring at one of the locations described above. A maternal device can be attached to the breeding females. The device may be either permanently or temporarily affixed to the offspring, most likely as an electronic ear tag or neck collar, until such time as the maternal relationship of the offspring is determined. After this time the offspring device may be replaced by a permanent RFID in one of the locations described above. Once the proximity data have been collected, the proximity device may then be reused on the next batch of animals. This approach may be used in order to bring the cost of determining relationships to beloW the cost of other technologies such as DNA technologies. Alternatively the device may be attached to the animal for an extended duration or for the whole of life of the animal.

The proximity analysis system is configured to receive and analyse data from identifiers (or associated devices) or from remote terminals/stations which have either received data from identifiers or have calculated and logged position data for the identifiers. The system generally includes a processing system to perform analysis of the proximity and position data. The processing system typically comprises at least a processor, data storage, an input device and an output device coupled together via a bus. An optional external interface may also be provided. The processing system is capable of executing computer readable instructions. The processing system is programmed to perform step (d) of the method of the invention, i.e. to analyse a proximity profile to determine whether the recorded interaction between two animals is indicative of a relationship between the animals. Optionally, the processing system may also be programmed to generate a proximity profile comprising information in relation to the frequency and duration of incidences of proximity between two animals, e.g. based on raw position data or non-validated proximity event.

The proximity analysis system is typically located remotely from all of the animals. However it could also be located on the animal, where it could be either integrated with an identifier, or more typically, separate from the identifier.

If not located on animals themselves, the proximity analysis system may be located centrally worldwide and used to analyse data from identifiers in a number of countries. Conversely there may be many proximity analysis systems located in many countries or regions, analysing data within each country or region. The proximity analysis system could also be configured to operate over the internet in the form of an ASP model (Application Service Provider).

Some identifiers will be a single technology. Others will comprise a combination of technologies or components.

Depending on the method used to capture data, identifiers may also comprise one or more of the following: a transmitter, a receiver, a controller, data storage and a power source. The power source which may be in the form of rechargeable batteries, insulated fuel cells powered by fuels derived from hydrogen, methanol, ethanol, alcohol, zinc, or aluminium, solar powered or powered by some other mechanism.

In one embodiment, the identifiers are radio frequency identification devices (RFIDs). The RFIDs may be passive or active. The RFIDs will typically store a unique animal ID for each animal. They may also store information about each animal its date or period of birth, sex, ownership, group or other records. This device typically encoded with a unique identification reference number. These devices may be an ISO (International Standards Organisation) Encoded Microchip, known as FDX-B chips which are ISO compliant and encoded with a unique number worldwide, or a Proprietary Encoded Microchip which are non-ISO compliant that are encoded with a number assigned by the manufacturer.

The records generated and stored by the RFID Device can be uploaded into a computer software program. These records of proximity encounters and duration of proximity as recorded by the count of intervals and the frequency of the counts thereby enables these records to be analysed. The RFID Device and methodology described comprise the RFID solution which, for example, enables either:
(a) the relationship of the mother (dam) and that of the offspring to be determined.
(b) the relationship or period of proximity of one object to another to be determined.

### Capture of Data Based on Proximity—Logging Encounters

This method relies on an animal or animals having an identifier unit that includes a device capable of reading identifiers on other animals (termed “a reader”). It is not necessary to know the absolute location of animals, the system simply logs encounters when animals come within a predetermined range of one another. The minimum range will vary between species and relationships. For example the minimum range (e.g. for cattle) may be less than 3 metres, such as less than metre, or (e.g. for birds) less than 50 cm.

In one embodiment, a first candidate animal or animals have an identifier unit which is capable of reading the identity of other identifiers e.g. the identifier unit is an active RFID. A second candidate animal or animals have passive identifiers, such as passive RFIDs. For example, candidate parents may be fitted with an active RFID and candidate offspring may be fitted with a passive RFID. The reverse configuration could also be used. It is also possible for all animals to have active RFIDs. In the case of all animals having passive identifiers only, remote means will need to be provided to enable the identifiers to be interrogated. It is also possible for some or all animals to have both an active and a passive identifier.

Readers are able to ‘listen’ for the presence of other identifiers, whether passive or active. When within range of another identifier, the reader will register the presence of the other identifier and log and/or communicate externally the encounter as well as the ID of the other identifier. A timestamp will also be logged. The reader will typically either continue to log proximity at defined intervals whilst the other identifier is in range or count using an internal clock until the other identifier is out of range and then record the duration when the other identifier was in range. This information may be stored on the device for subsequent retrieval. Alternatively it may be communicated by wireless transmission in real time or when in range.

The general operation of active and passive identifiers such as RFIDs is well known in the art.

In one embodiment, the RFID device combines a mix of the following components which may include existing technology, and or new components to create a new type of reusable RFID device:
(a) a radio receiver device which is used to read the encoded individual reference number of other devices e.g. ID devices fitted to female animals (maternal ID devices).
(b) a programmable and reusable microchip with data storage capabilities.
(c) a radio transmitter which emits a low-frequency radio signal that is received by the coil antenna contained in the device. This electromagnetic field powers the integrated circuit in the device and instructs the coil antennae to draw a variable amount of power from the RFID device which enables the RFID device in turn to read and store the details referred to above about the encoded number of device.
(d) A power supply for the device which may be in the form of rechargeable batteries or insulated fuel cells powered by fuels derived from hydrogen, methanol, ethanol, alcohol, zinc, or aluminum.

In an embodiment, the RFID device is a reusable device which can be programmed to record a particular animal ID, e.g. when the RFID device is first attached to the offspring. Being reusable, the device can be reused and reprogrammed for other animals, e.g. offspring from different mating periods within the same year or in subsequent years.

In an embodiment, to prevent the recording of incidences of proximity to animals that cannot be related e.g. to an offspring ID device itself or to other offspring ID devices (as opposed to maternal ID devices), a range of numbers for those animals that are to be excluded can also be stored e.g. a range of all encoded numbers (or parts thereof) allocated to a specific year (i.e. the current year) can also be stored.

In an embodiment, the RFID Device stores a date and time based log of counts of instances of encounters with other devices e.g. an individual maternal ID device, over minimum specified intervals. For a count of instances to be recorded, the encounter with another devices, e.g. a maternal ID device, will typically meet a minimal interval count. Logs of interval counts are only recorded where encounters with other devices, e.g. maternal ID devices take place within a specified proximity or signal range of the RFID device during a specified period of days, or as may be limited by the life of the power supply.

In one embodiment, interval counts are only logged when a minimal interval count has been reached. For example, the interval counts are designed to match a minimal period when the offspring is feeding from its lactating mother.

In another embodiment, the recording of intervals of the proximity of one device, e.g. a Maternal ID Device can be halted for a specified period of time by the presence of a second device from the same class of animal e.g. another maternal ID Device, thereby improving the quality and reliability of the count of incidences.

Another example of a suitable technology is a proximity logger available from Sirtrack Wildlife Tracking Solutions (www.sirtrack.com). Sirtrack's proximity logger works in the following way:

The proximity logger system includes a UHF transceiver that broadcasts a unique ID code, while simultaneously ‘listening’ for others. Each unit also contains a VHF transmitter which pulses at a nominated rate just like a normal beacon. When two or more units are within range and their ID code(s) are detected, the receiving unit queries an onboard real-time clock (RTC) and begins counting. Once the contact is broken for a user definable period of time, the ID code, date, time of contact and the duration of contact of the transmitting unit are stored into a non-volatile memory. The other unit(s) also ‘listening’ do the same, logging ID, date and time data in the same way.

### Transmitting Proximity Data to the Proximity Analysis System

Identifier units and associated devices may use any suitable wireless transmission means, such as the same or different radio frequency, a mobile telephone or satellite communication network to communicate proximity data from the identifier to the proximity analysis system.

By way of example, proximity data may be communicated to the proximity analysis system:
in real time by one or more radio frequencies and not stored or logged on the identifier unit;
logged on the identifier unit and communicated at specified intervals or when in radio range;
via a sensor network or wireless mesh network either in real time, at specified intervals or when in radio range;
logged on the identifier unit and subsequently retrieved wirelessly using Bluetooth, Wi-Fi or some other radio communication device;
logged on the identifier unit and subsequently retrieved by attaching a cable such as RS232, USB, firewire etc.

### Capture of Position Data

Another method for generating proximity data is based on recording the position of animals over time, either in absolute terms or relative to a fixed point, and subsequently processing the position data to generate proximity data as s, 30 s or minute intervals.

One example of a suitable technology is the Global Positioning System (GPS) or similar. Other methods include the use of one or more fixed base stations which either interrogate identifiers or receive ID signals transmitted by active identifiers. The invention is further described with reference to a GPS device but it will be appreciated that the following applies to any similar device. Animals may be fitted with a GPS device that logs (and/or communicates) the position of each animal over time. The coordinates obtained using GPS may be longitude and latitude only or more optionally include altitude. Alternatively elevation data for a given coordinate of longitude and latitude may be derived from a remotely located database. The distance between two animals may then be computed using either a 2 or 3 dimensional Euclidean metric, or a 2 or 3 dimensional spherical metric.

This GPS solution therefore provides a methodology and system which records longitude and latitude coordinates of the movement of animals over time as recorded by GPS receiver devices (Animal GPS Unit) attached to all animals, such as all mothers and their offspring.

In one embodiment, the GPS records of movements of both mothers and offspring in the form of coordinates of longitude and latitude and their respective encoded identification reference numbers of the maternal ID Device and the offspring ID Device are downloaded from the GPS device into a software program. These records are then analysed to determine the periods and level of proximity of both mothers and offspring. Mothers and offspring which are identified as having had brief (or extended) and irregular but repeated periods of close proximity are thereby able to be uniquely determined as being mother and offspring.

In another embodiment, the analysis of GPS records and RFIDs generated by males and mothers at the time of joining may enable the parents of offspring to be identified or at least limited to a small number of possible fathers.

GPS devices are well known in the art and are available commercially. Alternatively, the GPS device could be a purpose built device.

The information generated by each animal's GPS device includes the animal's ID, GPS coordinates and timestamp information once communicated to the proximity analysis system is used to determine the relationship between animals.

The GPS device generates coordinate information, such as longitude and latitude coordinates of the animal's physical location at predetermined intervals. This information may be stored on the device for subsequent retrieval. Alternatively it may be communicated by suitable wireless communication means in real time to the proximity analysis system. The other nearby device or devices also operate in the same way.

These position data can be converted to proximity data as described above. This processing is typically performed by the proximity analysis system.

### Transmitting Position Data to the Proximity Analysis System

GPS devices and the like may use any suitable wireless transmission means, such as radio, a mobile telephone or satellite communication network to communicate proximity data to the proximity analysis system.

Position data may be communicated to the proximity analysis system as described above for proximity data and identifier units.

An alternative to the GPS system is based on the use of remote scanning systems that can interrogate passive identifiers from a distance, such as passive RFIDs, including both RFID chips and RFIDs printed using conductive inks.

An example of this could be based on the use of radar (a single unit or a plurality of units) to measure the distance and angle to any given identifier and generate coordinates and a time stamp of the position of an individual animal through triangulation.

The information generated by such a system about each animal's position over time be similar to that generated by using a GPS device as described above and would therefore include animal IDs, position coordinates and time stamp information. When communicated to the proximity analysis system this information can be used to determine the relationship between animals in the same way as for the GPS device.

The radar unit may optionally include a transmitter to transmit data to the proximity analysis system.

A suitable system is manufactured by TrolleyScan (Pty) Ltd, South Africa (www.rfird-radar.com). Typically, the radar makes two measurements on each signal received from each transponder in its receiving zone—namely a range measurement and an angle of arrival. The system uses the same transponders that are used by conventional RFID readers allowing RFID-radars and RFID readers to monitor the same transponder simultaneously.

RFID-radar uses just 10 kilohertz of bandwidth to operate, meaning it can detect time differences as small as 0.1 milliseconds. The radar is able to determine the range of the transponder based on its received transmission to an accuracy of a few centimeters.

Like the system based on the GPS device, this system is used to generate coordinate information such as longitude and latitude coordinates (i.e. xy, and optionally z either as calculated or derived from an external database of elevation data) for an animal's physical location at specified intervals, together with a timestamp.

These position data can be converted to proximity data as described above. This processing is typically performed by the proximity analysis system, or locally prior to transmission to the proximity analysis. Position/proximity data can be transmitted to the proximity analysis system as described above.

Another method that can be used is based on a combination of devices that can record the position of animals, either in absolute terms or relative to a fixed point, e.g. the GPS devices described above, but which are also able to determine when the device is within range of another animal, e.g. using RFID technology. According the devices not only log proximity between animals but also log the position of at least some of the animals.

A particular example is a system that uses a combination of GPS devices and passive RFID devices to analyse proximity interactions between animals. Such a system is available from Bluesky Telemetry Ltd. (Glasgow, UK). Some of the animals are fitted with a GPS collar (e.g. adult female cows) whereas other animals are tagged with passive sensors (e.g. offspring). When an animal fitted with a GPS collar comes within range of another animal, this proximity event is recorded as well as the position of the animal with the collar. The proximity and position data can be transmitted to the proximity analysis system in a similar manner as to that described above.

Other possible technologies for data capture include the use of balloons, aircraft or other aerial vehicles, including unmanned vehicles, and the use of triangulation methods. Triangulation may take place either by the device on the animal or remotely from the animal. Both GPS and Radar RFID use triangulation methods and adjust for error (for example differential GPS devices in conjunction with reference stations, can be used to minimise position error). However, a range of other technologies could be used in conjunction with triangulation techniques in order to monitor and or determine proximity data from position differences between animals. This may include triangulation of position of identifiers which may have either passive or active RFID identifiers, using for example tracking and triangulation of position of an active identifier using mobile or cell phone technologies which may optionally incorporate a built in GPS capability; remote triangulation of radio transmissions emitted from an active identifier; or triangulation of passive or active identifiers using electromagnetic radiation other than radio waves or radar. A variation to these technologies includes the use of RFID receivers combined with thermal heat sensors attached to aerial vehicles which enables the position of identified animals to be accurately determined at night. The resulting position data can be analysed as described above.

The various features and embodiments of the present invention, referred to in individual sections above apply, as appropriate, to other sections, mutatis mutandis. Consequently features specified in one section may be combined with features specified in other sections, as appropriate.

Various modifications and variations of the described methods and products of the invention will be apparent to those skilled in the art without departing from the scope of the invention. Although the invention has been described in connection with specific preferred embodiments, it should be understood that the invention as claimed should not be unduly limited to such specific embodiments. Indeed, various modifications of the described modes for carrying out the invention which are apparent to those skilled in the relevant fields are intended to be within the scope of the following claims.

1. A method of determining a relationship between a first animal and a second animal, which method comprises the steps of:
(i) generating a proximity profile comprising information in relation to the frequency and duration of incidences of proximity for a candidate first animal in relation to the one or more candidate second animals; and
(ii) analysing the proximity profile to determine whether the interaction between the candidate first animal and any of the candidate second animals is indicative of a relationship between the animals.

2. A method of determining a relationship between a first animal and a second animal, which method comprises the steps of:
(a) providing one or more candidate first animals with an identifier;
(b) providing one or more candidate second animals with an identifier;
(c) generating a proximity profile comprising information in relation to the frequency and duration of incidences of proximity for a candidate first animal in relation to the one or more candidate second animals; and
(d) analysing the proximity profile to determine whether the interaction between the candidate first animal and any of the candidate second animals is indicative of a relationship between the animals.

3. A method according to claim 2 wherein the identifiers are electronic identifiers.

4. A method according to claim 2 or claim 3 wherein the identifiers comprise an RFID device.

5. A method according to claim 4 wherein the identifiers for the first animal(s) comprise an active RFID device.

6. A method according to claim 4 wherein the identifiers for the first animal(s) comprise a passive RFID device.

7. A method according to any one of claims 4 to 6 wherein the identifiers for the second animal(s) comprise an active RFID device.

8. A method according to any one of claims 4 to 6 wherein the identifiers for the second animal(s) comprise an passive RFID device.

9. A method according to claim 3 wherein the electronic identifiers can determine the longitude and latitude, and optionally the altitude, of the identifier's position.

10. A method according to claim 9 wherein the electronic identifiers comprise a transmitter for transmitting longitude and latitude data to a remote receiver.

11. A method according to claim 10 wherein the data are transmitted periodically according to a predetermined schedule.

12. A method according to any one of claims 9 to 11 wherein the electronic identifiers comprise data storage for storing longitude and latitude data.

13. A method according to any one of the preceding claims wherein incidences of proximity are recorded only when the proximity between a first animal and a second animal is less than a predetermined distance and the duration of proximity is greater than a predetermined time.

14. A method according to claim 13 wherein incidences of proximity are recorded only when the duration of proximity is within a predetermined time range.

15. A method according to any one of the preceding claims wherein data in relation to each animal's position or proximity are recorded over a period of at least 24 hours.

16. A method according to any one of the preceding claims wherein the proximity profile for a first animal and a second animal is compared with a table or database of proximity values to determine whether a relationship exists between the first and second animals.

17. A method according to claim 16 wherein the parameters comprise minimum duration of proximity and maximum duration of proximity.

18. A method according to any one of the preceding claims wherein the relationship to be determined is a social or genetic relationship.

19. A method according to any one of the preceding claims wherein the candidate first animals are candidate parents and the candidate second animals are candidate offspring and the relationship being determined is a patent/offspring relationship.

20. A method according to any one of the preceding claims wherein the animals suckle, feed or care for their offspring.

21. A system for determining a relationship between a first animal and a second animal, which system comprises:
(i) means for recording the frequency and duration of incidences of proximity between the animals to generate one or more proximity profiles; and
(ii) means for analysing one or more of the proximity profiles to determine whether the interaction between any of the first animals and any of the second animals is indicative of a relationship between the animals.

22. A system for determining a relationship between a first animal and a second animal, which system comprises:
(a) a plurality of identifiers for attachment to a plurality of first animals;
(b) a plurality of identifiers for attachment to a plurality of second animals;
(c) means for recording the frequency and duration of incidences of proximity between the animals to generate one or more proximity profiles; and
(d) means for analysing one or more of the proximity profiles to determine whether the interaction between any of the first animals and any of the second animals is indicative of a relationship between the animals.

23. A system for determining a relationship between a first animal and a second animal, which system comprises:
means for recording the position of the animals at a plurality of time points;
(ii) means for determining the frequency and duration of incidences of proximity between the animals using recorded position data to generate one or more proximity profiles; and
(iii) means for analysing one or more of the proximity profiles to determine whether the interaction between any of the first animals and any of the second animals is indicative of a relationship between the animals.

24. A system for determining a relationship between a first animal and a second animal, which system comprises:
(a) a plurality of identifiers for attachment to a plurality of first animals;
(b) a plurality of identifiers for attachment to a plurality of second animals;
(c) means for recording the position of the animals at a plurality of time points;
(d) means for determining the frequency and duration of incidences of proximity between the animals using recorded position data to generate one or more proximity profiles; and
(e) means for analysing one or more of the proximity profiles to determine whether the interaction between any of the first animals and any of the second animals is indicative of a relationship between the animals.

26. A system according to claim 22 or claim 24 wherein the identifiers are electronic identifiers.

27. A system according to any one of claim 22, 24 or 26 wherein the identifiers comprise an RFID device.

28. Use of a system according to any one of claims 22 to 27 in determining a relationship between a first animal and a second animal.
